(19) United States
(12) Patent Application Publication
(10) Pub. No.: US 2008/0107045 A1
(43) Pub. Date: May 8, 2008

(54) QUEUING VOIP MESSAGES

(76) Inventors: Viktors Berstis, Austin, TX (US); Randolph M. Forlenza, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/555,744

(22) Filed: Nov. 2, 2006

(51) Int. Cl. H04L 12/18; H04L 12/56

(52) U.S. Cl. 370/263; 370/412

(57) ABSTRACT

Methods and arrangements to play Voice over Internet Protocol (VoIP) messages are contemplated. Embodiments include transformations, code, state machines or other logic to play VoIP messages by receiving overlapping VoIP messages from a VoIP conference, placing at least one of the overlapping VoIP messages in a queue, and playing the overlapping VoIP messages one at a time. The playing may include retrieving the overlapping VoIP messages from the queue. The embodiments may include displaying the VoIP messages through a graphical user interface and receiving instructions from a user on the playing of the messages through the graphical user interface. In some further embodiments, the instructions may describe the order for playing the messages. In many further embodiments, the instructions may request the deletion of VoIP messages from the queue without the playing of the VoIP messages.

### FIELD

The present invention is in the field of audio communications over a network. More particularly, the present invention relates to methods and arrangements to queue VoIP messages.

### BACKGROUND

Voice over Internet Protocol (VoIP) is a method for the real-time exchange of speech and other audio over the Internet and other networks. Audio may be converted into digital form, broken up into units of data called packets, and transmitted across a network. Upon receipt, the packets are assembled, and the audio may be converted from digital form to analog form and played.

VoIP calls may be made by several methods. In one method, a call is placed from a standard telephone which is connected to a computer with an analog telephone adapter. The adapter converts sound into digital form for transmission over a network. In a second method, a call is made from an IP phone. The IP phone may convert audio to digital form. The IP phone may connect directly to an Ethernet port for transmission of the digital audio across a network. A third method is from a computer. The computer may include equipment for processing sound, such as a microphone to capture sound, a sound card to convert the sound to digital form, and speakers to play the sound. The computer may be connected to a network for transmission of the sound.

VoIP calls may be made in several settings. A VoIP call may be limited to one participant at each end. A VoIP call may be a conference call, with multiple participants. In addition, a VoIP call may be part of a chat conference. Chat conferences include the real-time exchange of text among groups of people.

In current VoIP conference systems, it may be difficult to understand everyone when several participants are speaking at once. A participant's VoIP system may play the VoIP messages containing the speech simultaneously, making it difficult for the participant to understand the contents of the VoIP messages. For example, a soft-speaking participant may be drowned out by a loud participant. Similarly, when several people are talking at once, understanding them all may be difficult, even if they are all speaking at moderate volumes. In addition, current VoIP systems may transmit messages received by one conference participant to the other participants. A participant may then be unable to keep a call received during a VoIP conference confidential.

### SUMMARY OF THE INVENTION

The problems identified above are in large part addressed by methods and arrangements to play Voice over Internet Protocol (VoIP) messages. One embodiment provides a method to play VoIP messages. The method may involve receiving overlapping VoIP messages from a VoIP conference, placing at least one of the overlapping VoIP messages in a queue, and playing the overlapping VoIP messages one at a time. The playing may include retrieving the overlapping VoIP messages from the queue.

### BRIEF DESCRIPTION OF THE DRAWINGS

Advantages of the invention will become apparent upon reading the following detailed description and upon reference to the accompanying drawings in which like references may indicate similar elements:

FIG. 1 depicts a network diagram of an embodiment of devices to queue Voice over Internet Protocol (VoIP) conference messages;

FIG. 2 depicts an embodiment of a computer capable of queuing VoIP messages;

FIG. 3 depicts an embodiment of a VoIP message queuer;

FIG. 4 depicts an embodiment of a system to transmit sound over a network;

FIG. 5 depicts a flowchart of an embodiment to queue VoIP messages and to play the queued messages; and

FIG. 6 depicts an example diagram of the queuing of overlapping VoIP messages.

### DETAILED DESCRIPTION OF EMBODIMENTS

The following is a detailed description of embodiments of the invention depicted in the accompanying drawings. The embodiments are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods and arrangements to play Voice over Internet Protocol (VoIP) messages are contemplated. Embodiments include transformations, code, state machines or other logic to play VoIP messages by receiving overlapping VoIP messages from a VoIP conference, placing at least one of the overlapping VoIP messages in a queue, and playing the overlapping VoIP messages one at a time. The playing may include retrieving the overlapping VoIP messages from the queue. The embodiments may include displaying the VoIP messages through a graphical user interface and receiving instructions from a user on the playing of the messages through the graphical user interface. In some further embodiments, the instructions may describe the order for playing the messages. In many further embodiments, the instructions may request the deletion of VoIP messages from the queue without the playing of the VoIP messages.

While specific embodiments will be described below with reference to particular circuit or logic configurations, those of skill in the art will realize that embodiments of the present invention may advantageously be implemented with other substantially equivalent configurations.

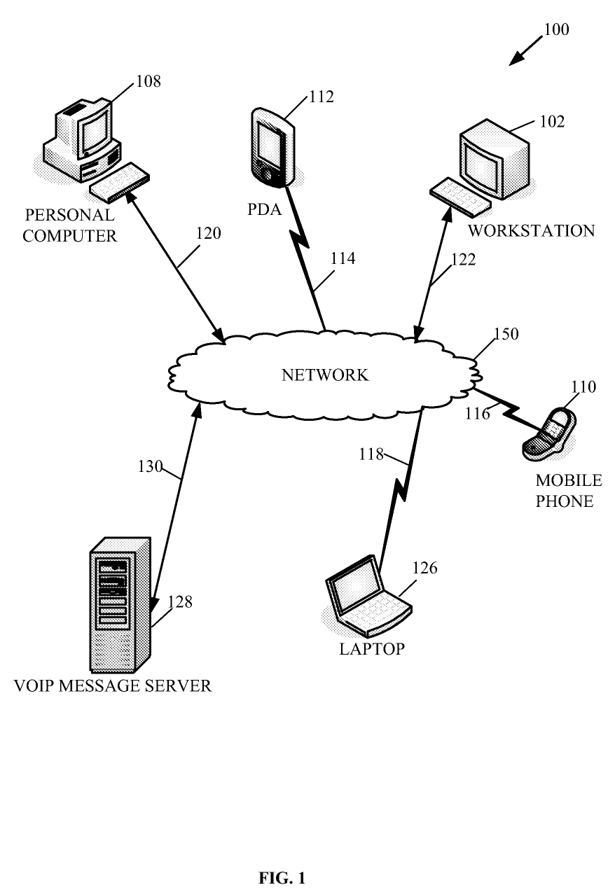

FIG. 1 depicts a diagram of an embodiment of a networked system 100 of devices capable of queuing messages from a VoIP conference. Networked system 100 may provide for the real-time exchange of speech and other audio over the Internet and other networks. The system 100 includes a network 150, VoIP message server 128 connected to network 150 through wireline connection 130, and a variety of devices capable of queuing messages from a VoIP conference (VoIP devices), including:
workstation 102, a computer coupled to network 150 through wireline connection 122,
personal digital assistant 112, coupled to network 150 through wireless connection 114,
personal computer 108, coupled to network 150 through wireline connection 120,
laptop computer 126, coupled to network 150 through wireless connection 118; and
mobile phone 110, coupled to network 150 through wireless connection 116.

### The VoIP devices may receive overlapping VoIP messages, queue at least one of the overlapping VoIP messages, retrieve the VoIP messages from the queue, and play the VoIP messages one at a time.

Network 150, which may consist of the Internet or another wide area network, a local area network, or a combination of networks, may provide data communications among the VoIP message server 128 and the VoIP devices 102, 108, 112, 126, and 110. VoIP message server 128 may have installed and operative upon it software to transmit VoIP messages across network 150. VoIP message server may receive a request to make a VoIP call. For example, VoIP message server 128 may receive digital data representing a telephone number. VoIP message server 128 may determine that the request to make a VoIP call is in proper format, and may determine an IP address for a recipient or recipients. VoIP message server 128 may connect the device placing the VoIP call with a destination device. A session may then be established between the calling device and the destination device. VoIP message server 128 may administer VoIP conferences. VoIP conferences include more than two participants. In some embodiments, VoIP message server 128 may administer a chat conference which includes VoIP. A chat conference may be the real-time exchange of text messages among a group of people. In still other embodiments, VoIP messages may be transmitted without a server such as VoIP message server 128.

Users may participate in VoIP conversations through VoIP devices such as devices 102, 108, 112, 126, and 110. In some embodiments, participants in a VoIP conversation may run client software on their VoIP devices. When a participant opens a client, the client may attempt to connect with VoIP message server 128. If the connection is successful, the client may inform the VoIP message server 128 of the participant's Internet Protocol (IP) address, a number identifying the VoIP device, and the number of a port assigned to the client. In other embodiments, a participant may visit a web site to participate in a VoIP call. In some embodiments, a VoIP message may be transmitted across the network 150 to the VoIP message server 128 and may be relayed to the other participants by VoIP message server 128. In other embodiments, the VoIP message may be transmitted from one participant to others without being relayed through the VoIP message server 128. A client running on a participant's VoIP device may have obtained connection information such as IP addresses and ports from the VoIP message server 128. The VoIP messages may be sent under a variety of protocols, or methods for bundling up the digital content and transmitting the digital content across network 150. When a client sending a VoIP message sends it by a protocol understood by the client receiving the message, the receiving client may understand the format of the VoIP message and the manner in which the VoIP message was sent across the network 150, and may be able to properly process it. Protocols for transmitting VoIP across a network such as network 150 include H.323, a standard created for multimedia data including audio and video by the International Telecommunication Union (ITU); Media Gateway Control Protocol (MGCP); and Session Initiation Protocol (SIP).

The arrangement of the server and other devices making up the exemplary system illustrated in FIG. 1 is for explanation, not for limitation. Data processing systems useful according to various embodiments of the present invention may omit a server, or may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

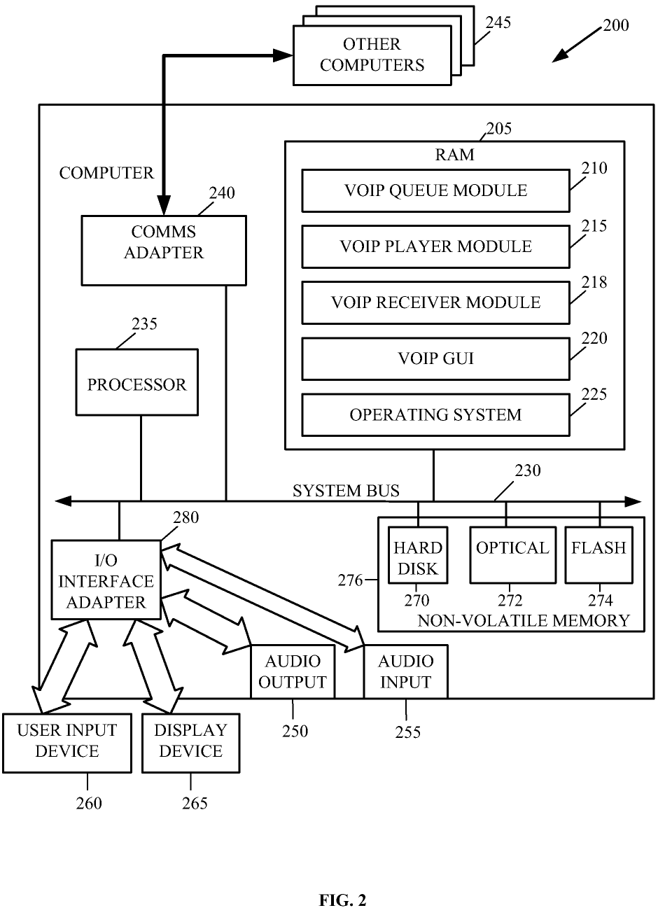

Turning to FIG. 2, depicted is an embodiment of a computer 200 capable of queuing messages from a VoIP conference that includes random access memory (RAM) 205, a processor 235 or CPU, non-volatile memory 276, a communications adapter 240, and an Input/Output (I/O) interface adapter 280 connected by system bus 230. Stored in RAM 205 is a VoIP queue module 210, a VoIP player module 215, a VoIP receiver module 218, a VoIP graphical user interface (GUI) 220, and an operating system 225.

VoIP queue module 210 may comprise computer program instructions for queuing a plurality of VoIP messages. The VoIP messages may be stored in RAM 205, in non-volatile memory 276, or in removable drives or media not shown. A variety of methods may be used to order the VoIP messages in the queue. In some embodiments, the messages may be kept in a first-in first-out (FIFO) queue. The VoIP queue module 210 may select the earliest-received message for retrieval and playing. If two messages are received at exactly the same time, a tie-breaking scheme may be used to determine which one to queue first. In a FIFO queue, messages may be played in chronological order. In many embodiments, the messages may be retrieved according to instructions from a user. The user may designate a specific VoIP message or category of messages to be retrieved and played, may designate a specific VoIP message or category of messages to be held in the queue without playing, or may designate a specific VoIP message or category of messages to be deleted without playing. For example, a user may specify that messages from a company president should be retrieved from the queue before any other messages. As another example, a user may decide that a conference participant is discussing unimportant matters and specify that the participant's messages should be placed in the back of the queue. In some embodiments, a user may specify that messages from a certain department should receive priority.

VoIP player module 215 may comprise computer program instructions to play VoIP messages. The instructions of VoIP player module 215 may provide for playing messages one at a time, completing the playing of one message before beginning the playing of another message. The messages may be retrieved from the queue maintained by VoIP queue module 210.

VoIP receiver module 218 may comprise computer program instructions to receive VoIP messages from participants in a VoIP conference. The instructions may provide for the receipt of overlapping VoIP messages. VoIP messages may overlap if playing the VoIP messages as received would cause portions of the VoIP messages to be played simultaneously. The instructions of VoIP receiver module 218 may provide for keeping separate the VoIP messages that are received, rather than combining the audio from two or more VoIP messages. The instructions may provide for transferring at least some of the overlapping VoIP messages for queuing. In some embodiments, all VoIP messages may be transferred for queuing. In other embodiments, some messages may be sent directly for playing without first being queued when no message is currently being played.

VoIP GUI 220 may comprise computer program instructions for displaying queued VoIP messages and for receiving instructions from a user for the disposition of the VoIP messages. In some embodiments, VoIP GUI 220 may generate a scrollable window displaying a list of the messages with such attributes as sender and time of receipt or time of transmission. In further embodiments, a use may click on a message to play it. In some of these further embodiments, a user may right click on a message to obtain a menu of possible dispositions. In many embodiments, a message may gray out after playing, and the list of the messages may be centered on unplayed messages. A user may scroll through the window to a previously-displayed message and click on the message to replay it. In several embodiments, a user may request a delay in the playing of designated messages through VoIP GUI 220. In some further embodiments, the user may designate specific messages. In many further embodiments, the user may designate a category of messages for delay, such as all messages from a particular user. In several embodiments, a user may request to be alerted upon receipt of VoIP messages in a specified category, such as all messages from a particular person. In other embodiments, the user may request that VoIP messages in a specified category be played immediately upon receipt, or otherwise be given highest priority.

The delay feature may enable a user to protect the privacy of a VoIP message. The user may choose to delay the playing of a private VoIP message until a VoIP conference ends. Otherwise, in some VoIP systems, the playing of the private VoIP message would cause it to be broadcast to the other participants in the VoIP conference.

Operating system 225 may comprise UNIX™, Linux™, Microsoft Windows™, AIX™, IBM's i5/OS™, or other operating systems useful for queuing messages from a VoIP conference as will occur to those of skill in the art. VoIP queue module 210, VoIP player module 215, VoIP receiver module 218, VoIP GUI 220, and operating system 225 (components of software) are shown in RAM 110 in FIG. 2, but many components of such software may be stored in non-volatile memory 276 also. Further, while the components of such are shown simultaneously present in RAM, in other embodiments, only some of the components of RAM 205 may be present at any given time

I/O interface adapter 280 implements user-oriented I/O through, for example, software drivers and computer hardware for controlling output to display devices such as display device 265 and audio output device 250 as well as user input from user input device 260 and audio input device 255. User input device 260 may include both a keyboard and a mouse. Some embodiments may include other user input devices such as speech interpreters, bar code scanners, text scanners, tablets, touch screens, and/or other forms of user input devices. Audio output 250 may include speakers or headphones and audio input device 255 may include a microphone or other device to capture sound. Non-volatile computer memory 276 may be implemented as a hard disk drive 270, optical disk drive 272, electrically erasable programmable read-only memory space (EEPROM or Flash memory) 274, RAM drives (not shown), or as any other kind of computer memory as will occur to those of skill in the art.

Communications adapter 240 may implement the hardware level of data communications through which one computer sends data communications to other computers, such as other computers 245, directly or through a network. Such data communications may be carried out through serially through RS-232 connections, through external buses such as USB, through data communications networks such as IP networks, and in other ways as will occur to those of skill in the art. Examples of communications adapters include modems for wired dial-up communications, Ethernet (IEEE 802.3) adapters for wired network communications, and 802.11b adapters for wireless network communications.

The computer and components illustrated in FIG. 2 are for explanation, not for limitation. In other embodiments, embedded systems, PDAs, cell phones, and other network-enabled devices which may transmit, receive, and store VoIP messages may queue VoIP messages and play them one at a time. In other embodiments, a modules to queue, play, receive, and display VoIP conference messages may be implemented in hardware, firmware, or in state machines or may form a component of an operating system.

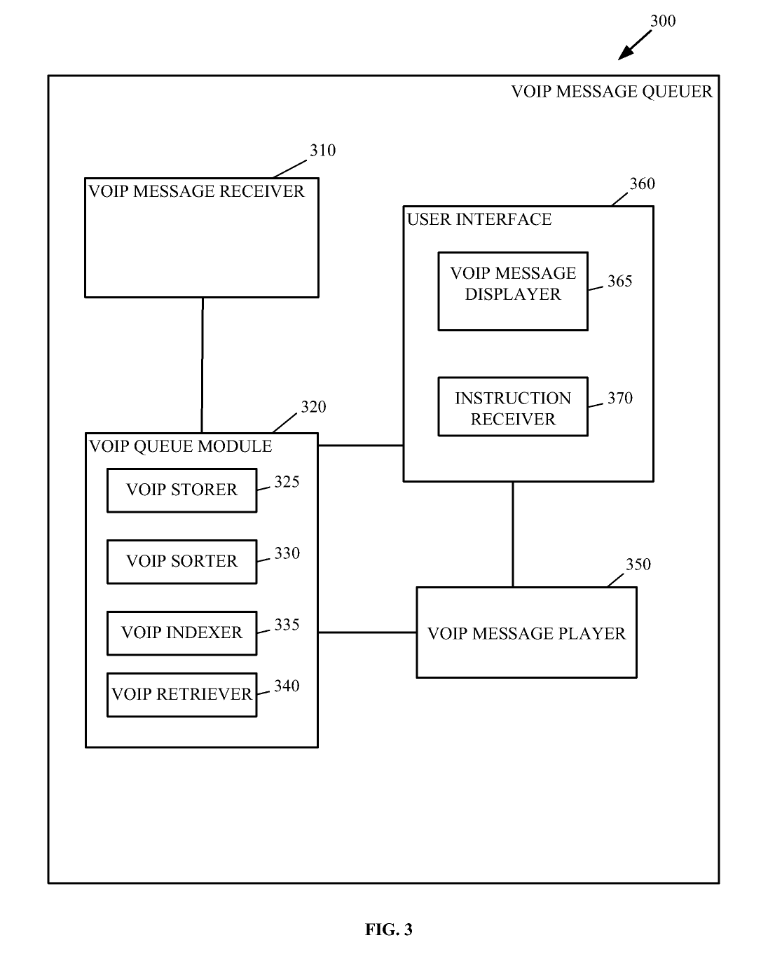

FIG. 3 illustrates an embodiment of a VoIP message queuer 300 that includes a VoIP message receiver 310, a VoIP queue module 320, a VoIP message player 350, and a VoIP user interface 360. VoIP message receiver 310 may receive VoIP messages from VoIP conferences. The VoIP messages may be overlapping. Several participants in a VoIP conference may be speaking simultaneously. VoIP message receiver 310 may keep the audio portions of the overlapping messages separate and may transfer at least some of the VoIP messages to VoIP queue module 320. In some embodiments, VoIP message receiver 310 may transfer all VoIP messages it receives during VoIP conferences to VoIP queue module 320. In other embodiments, VoIP message receiver 310 may transfer a VoIP message from a VoIP conference to VoIP message player 350 when no VoIP message is currently being played. VoIP message receiver 310 may be implemented in hardware or software. For example, VoIP message receiver 310 may consist of a network interface card, a USB port, or a terminal adapter on a PCI (peripheral component interconnect) card.

VoIP queue module 320 stores and retrieves VoIP messages. VoIP queue module 320 includes VoIP storer 325, VoIP sorter 330, VoIP indexer 335, and VoIP retriever 340. VoIP storer 325 receives VoIP messages from VoIP message receiver 310 and stores them in a queue. VoIP sorter 330 orders the VoIP messages in the queue. In many embodiments, the queue is FIFO. The earliest received VoIP messages are retrieved first and may therefore be played in the order of receipt. In some embodiments, the VoIP messages may be ordered according to instructions received from a user through user interface 360.

VoIP indexer 335 produces an index of the VoIP messages in the queue for display by user interface 360. The index may present attributes of the VoIP messages such as the sender and the time received. In some embodiments, such as a VoIP chat conference which combines voice and text, the index may present the subject of the messages. VoIP retriever 340 retrieves VoIP messages from the queue for transfer to VoIP message player 350. VoIP retriever 340 may refrain from transferring an additional VoIP message to VoIP message player 350 until VoIP message player 350 has completed the playing of a previous VoIP message.

VoIP message player 350 may consist of a sound card and speakers to convert digital sound into analogue. VoIP message player 350 may play VoIP messages one at a time. In some embodiments, VoIP message player 350 may obtain all VoIP messages from a VoIP queue and may retrieve a new message only when it has finished playing a previous message. In other embodiments, VoIP message player 350 may include a VoIP message buffer. When it has completed the playing of one VoIP message, VoIP message player 350 may transfer another VoIP message from the buffer. In further embodiments, VoIP message player 350 may retrieve messages from the VoIP queue and insert them in the buffer even when it is currently playing a VoIP message.

User interface 360 displays attributes of VoIP messages in the VoIP queue and receives instructions from a user about the retention and playing of VoIP messages. User interface 360 includes VoIP message displayer 365 and instruction receiver 370. VoIP message displayer 365 may display attributes of VoIP messages contained in the queue which were produced by VoIP indexer 335. VoIP message displayer 365 may generate a scrollable window that displays the VoIP messages from the queue by attributes. A user may click or right-click on a message to issue a command about the message, such as to play the message, to delete the message, or to forward the message. Instruction receiver 370 may receive instructions from a user about the disposition of VoIP messages in the queue that cannot be given through interactions with VoIP message displayer 365. In some embodiments, for example, a user may specify an interval to delay the playing of VoIP messages after receipt. In many embodiments, the instructions may specify the disposition of VoIP messages. For example, VoIP messages may be deleted after playing, after a certain time interval, at the end of a session, or only when a user specifically requests their deletion. The instructions may also specify the ordering of VoIP messages in the queue.

The VoIP message queuer 300 may enable the playing of overlapping VoIP messages from a VoIP conference one at a time. The overlapping VoIP messages may be received by VoIP message receiver 310, inserted in a queue by VoIP queue module 320, and retrieved sequentially for playing by VoIP message player 350. VoIP message player 350 may begin to play the next-retrieved message only after it has completed the playing of the previously-retrieved message.

FIG. 3 is for illustration and not limitation. In some embodiments, a user interface may omit the display of specific VoIP messages. In further embodiments, the user may be able to request the playing of the next message without specifying a particular message. In these embodiments, a VoIP indexer may be omitted. In some embodiments, the components of the modules may be combined in different ways. For example, the VoIP player may queue the VoIP messages in a self-contained buffer.

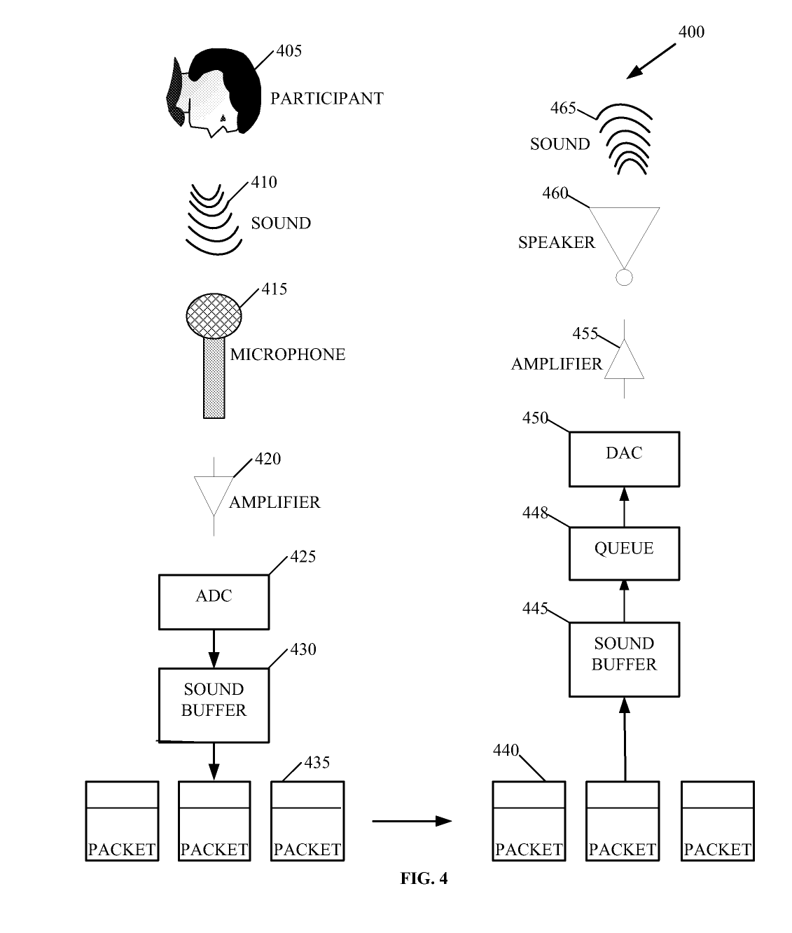

FIG. 4 depicts an embodiment of a system 400 to transmit sound across a network. System 400 may receive overlapping VoIP messages from a VoIP conference, queue some or all of the overlapping VoIP messages, and play the overlapping messages one at a time by retrieving the messages from the queue.

System 400 includes a microphone 415, two amplifiers 420 and 455, an analog to digital converter 425, a digital to audio converter 450, two sound buffers 430 and 445, and sound packets 435 and 440. Participant 405 in a VoIP conference may produce sounds, such as sound 410, for example, by speaking. The sound may also be non-verbal. In alternative embodiments, the sound may be produced by an agency other than a participant. Microphone 415 may convert the sound waves constituting sound 410 into electrical signals. The sound waves may produce vibrations in a diaphragm, a thin plate contained in the microphone; and the vibrations of the diaphragm may induce electrical signals. In some embodiments, the microphone 415 may be a component of a VoIP device, such as a built-in microphone in a computer or a cell phone. In alternative embodiments, the microphone may plug into the VoIP device. For instance, a microphone jack may plug into a computer. Amplifier 420 boosts or increases the strength of the electrical signals produced by the microphone.

The signal then proceeds to an analog to digital converter (ADC) 425, which converts the electrical waves to digital form. ADC 425 may measure the electrical signals produced by the microphone at a predetermined frequency (‘sample’ the signals), and may represent the waveform amplitude at a given point in time as a binary number by dividing the possible values of the amplitude into ranges and representing each range with a binary number. For example, an ADC that encodes the signal as an 8-bit number may divide the amplitude of waves into 256 ranges. For each sample, the ADC 425 may determine the range in which the wave amplitude falls. The 8-bit ADC may find that successive amplitudes fall into the range of 128, 135, and 180 in successive samples. The ADC may return the numbers 128, 135, and 180 as the value of those samples. Similarly, if the amplitude is encoded as a 16 bit number, representation as one of 65,566 amplitude values would be possible. Choosing a different number of bits in this way can improve the amplitude precision as more bits are used, at the cost of transmitting more data.

The sampling rate may depend upon the protocol used for the transmission of sound across a network. Common protocols include the G.711, G.722 and G.720 protocols, audio components of the H.423 protocol suite promulgated by the International Communication Union for video conferencing. Under the G.711 protocol, sampling occurs 64,000 times per second (64 kHz). Under the G.729A protocol, sampling occurs at 8 kHz. This protocol is the most commonly used by Voice over Internet Protocol (VoIP) systems. The sampling rate of 8 kHz provides a good compromise between sound quality and bandwidth efficiency. In contrast, typical CD recordings may sample at the rate of 44.1 kHz. A computer sound card may contain an ADC.

The sampling of the electrical signal produced by microphone 415 may generate a large amount of data. At a resolution of 16 bits and a sampling rate of 48 kHz, an ADC may produce roughly six megabytes of data per minute of sound. The data produced by ADC 425 may be stored in sound buffer 430 for further processing. The data may be copied from sound buffer 430 to other storage for later retrieval. For example, VoIP messages may be moved from sound buffer 430 to more permanent storage for later retrieval. As a further example, a VoIP message relayed through a computer may be stored for later retrieval in the memory of the computer.

The data in sound buffer 430 may be transmitted across a network. The data may be transmitted uncompressed or may be compressed for more efficient transmission. Uncompressed sound data may be represented as WAV files. A WAV file may include a small header with information about size, sample rate, and other facts. The remainder of the file may consist of digital numbers representing the magnitude of the sound waves at the sampling points. Methods of compression include MPEG, layer three of a standard developed by the Moving Picture Experts Group for the compression of audio-digital information. Compression may reduce the size of data by a factor of 10 or more.

The data, compressed or not, is then divided into packets 435 or small pieces of information for transmission over the internet. The packets contain the actual sound data and other information, such as the source and destination internet addresses, information about the protocols being followed for transmission, information about the format of the sound data file, and information for reassembling the packets. In addition to H.423, other protocols commonly used for the transmission of audio include the Session Initiation Protocol, a protocol designed especially for VoIP, and Media Gateway Control Protocol. Other protocols can be used for transmitting VoIP messages. In particular, proprietary protocols may be used during VoIP conferences, since all participants may use the same conference software.

The packets 435 may be transmitted across the internet to a network device of a recipient. There, the packets may be converted to sound by a process which is roughly the reverse of the process of transforming sound into packets. The arriving packets 440 are stored in a sound buffer 445 and may be assembled and transformed into an uncompressed digital sound file. The sound buffer 445 may gather packets until the entire data from a transmission has been collected. Alternatively, the sound buffer 445 may gather enough packets to produce sound for a certain duration, and then pass on the packets for transformation into sound and playing the sound while additional packets continue to gather. This process of playing a portion of the sound while packets containing other portions of the sound are still arriving is called “streaming.”

The assembled digital sound file may be placed in queue 448. One sound file at a time may be removed from queue 448 and sent to the DAC converter 450, which converts the digital files into analog electrical waves. Computer sound cards frequently contain a DAC converter. The waves are amplified by amplifier 455 and sent through speaker 460 to produce sound 465. If the fidelity of system 400 is good, sound 465 may be very similar to sound 410. Even in relatively low-fidelity systems, when sound 410 is speech, sound 465 may be recognizable as the speech that produced sound 410.

Sound from overlapping VoIP messages may undergo the transformations illustrated in FIG. 4. The time intervals represented by the packets of the VoIP messages may overlap. For example, packets for the overlapping VoIP messages may be received at the same time, or a packet for one VoIP message may be received between the receipts of packets for another VoIP message. In the embodiment of FIG. 4, the overlapping VoIP messages may be played separately rather than combined. The packets of the separate VoIP messages may be assembled into separate sound files, and the sound files may be sent to the DAC 450 separately and played separately. DAC 450 may convert one digital sound file at a time and send it to amplifier 455 rather than combining two sound files and then converting the combined file.

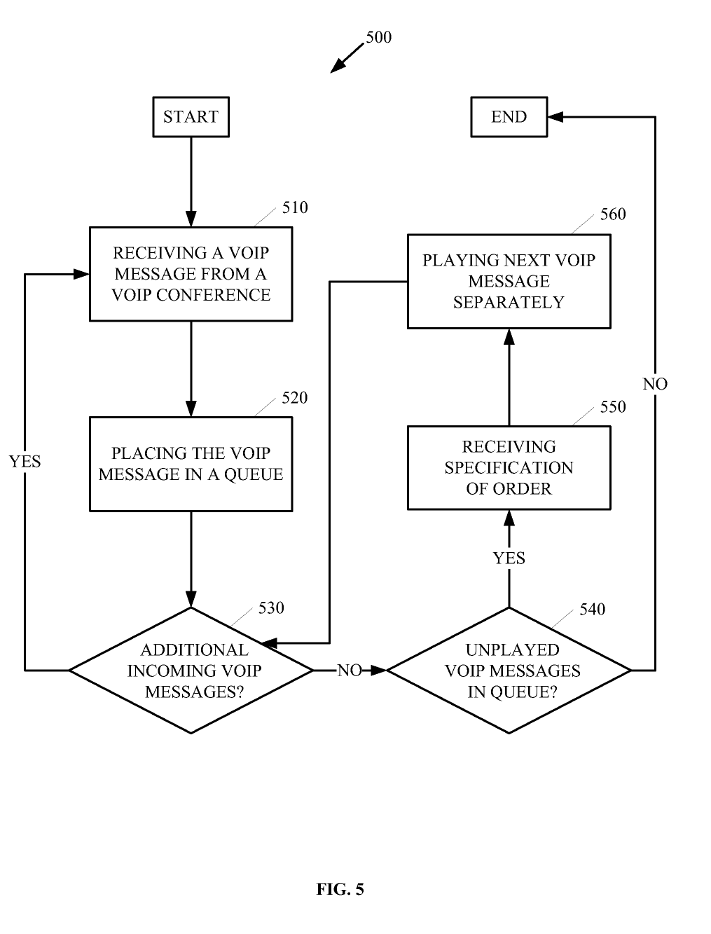

FIG. 5 depicts a flowchart of an embodiment to queue VoIP messages and to play the queued messages. Flowchart 500 of FIG. 5 begins with receiving a VoIP message from a VoIP conference (element 510). In some embodiments, participants may delineate the start and end of VoIP messages by clicking on a mouse button or otherwise interacting with a user interface. In other embodiments, the VoIP messages may be automatically generated. For example, software may monitor the amplitude levels coming from a microphone and may automatically trigger the start of a message when some criteria is satisfied, such as an amplitude level above some threshold, or the amplitude level exceeding some thresholds multiple times in a very small time interval. In further embodiments, the VoIP messages may include sound received by the microphone a millisecond or more before the threshold was exceeded. The sound is available, because all of the sound received by the microphone is temporarily stored. Similarly, the end of a message may be triggered by lack of any sound exceeding the threshold criteria for some short time interval such as 1 or 2 seconds. The actual message packet may exclude this trailing silence.

The message may be one of several overlapping messages received from participants in the VoIP conference. Several participants in the VoIP conference may be speaking or otherwise producing sound simultaneously. The receiving may include separating the message from the other messages. For example, if packets from several messages are received, the packets of the VoIP message may be assembled into a sound file separately from the packets of the other messages.

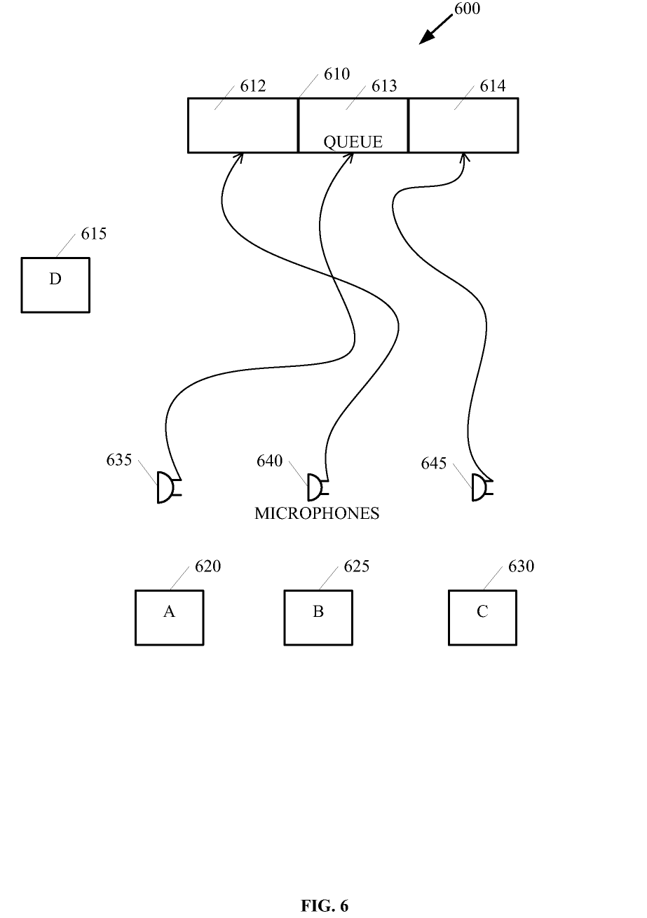

The VoIP message may be placed into a queue (element 520). The digital file containing the VoIP message may be placed in volatile or non-volatile storage. If several overlapping VoIP messages are received, each message may be stored in the queue separately. Turning to FIG. 6, depicted is an example diagram of the queuing of overlapping VoIP messages. FIG. 6 includes a queue 610; VoIP participants D 615, A 620, B625 and C630; and microphones 635, 640, and 645. Queue 610 may include storage cells 612, 613, and 614. Participants A, B, and C may be simultaneously speaking, with the sounds of their speech captured by microphones 635, 640, and 645 respectively. Participant D 615 may be listening to the other participants. The speeches may be processed separately and stored separately in the cells of queue 610. As indicated by the curved arrows, the sounds captured by the microphones 635, 640, and 645 are stored respectively in queue cells 613, 612, and 614. The sounds may be retrieved one at a time from the queue cells 612, 613, and 614 and played for listener D 615.

Returning to FIG. 5, flowchart 500 includes checking for additional incoming VoIP messages (element 530). If there are additional VoIP messages, elements 510 and 520 may be repeated. If there are not additional messages, flowchart 500 includes checking for unplayed VoIP messages in the queue (element 540). If there are no unplayed VoIP messages, the queuing and playing of VoIP messages may end. If there are unplayed VoIP messages, the queue may receive a specification of the order in which to play the messages (element 550). The default order may be first-in, first-out (FIFO). In this ordering, the first VoIP message placed into the queue is retrieved for playing. If two VoIP messages arrive simultaneously, a tie-breaking scheme may be used. Under the FIFO ordering, VoIP messages are played in chronological order. In some embodiments, a participant may specify a particular message to be played next. In many embodiments, a participant may specify a category of messages to be given priority, such as messages from a chief executive.

Flowchart 500 also includes playing the next VoIP message in the ordering, separately from other VoIP messages (element 560). A message player such as VoIP message player 350 in FIG. 3 may play the audio of the next VoIP message, without combining the audio with the audio of other VoIP messages. The method of flowchart 500 VoIP message may include performing an additional check for incoming VoIP messages (element 530).

Queuing the messages and retrieving them one at a time according to the method of FIG. 5 may enable all the participants at a VoIP conference to hear what everyone else is saying, even when several people are talking at once, as may be frequent during conference calls, and regardless of the relative volumes of the participants. A VoIP message carrying the faint speech of one participant may be played separately from a message carrying the loud simultaneous speech of other participants, enabling the faint speech to be heard. If necessary, the volume of the playback may be adjusted during the playing of the faint speech. Further, even when many people are talking at the same time, all the VoIP messages carrying their speech may be played separately, allowing their speech to be understood. In contrast, in a normal analog conference call, only the loudest person speaking may be heard when several are speaking simultaneously. The others trying to say something are not heard.

The elements of flowchart 500 are for illustration and not for limitation. In alternative embodiments, other elements may be included. For example, in some embodiments, VoIP messages in the queue may be deleted without being played. In many embodiments, VoIP messages may be retained in the queue after playing and may be replayed. In a few embodiments, there may be a delay before playing a message, either a fixed delay or a user-specified delay. In several embodiments, the elements of flowchart 500 may be executed simultaneously or in a different order. For example, a VoIP message from the queue may be played whenever a VoIP message is received or a check for additional VoIP messages may be performed simultaneously with the playing of the next VoIP message from the queue.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product for playing VoIP messages accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present invention contemplates methods and arrangements to queue VoIP messages. It is understood that the form of the invention shown and described in the detailed description and the drawings are to be taken merely as examples. It is intended that the following claims be interpreted broadly to embrace all the variations of the example embodiments disclosed.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method to play Voice over Internet Protocol (VoIP) messages, the method comprising:
receiving overlapping VoIP messages from a VoIP conference;
placing at least one of the overlapping VoIP messages in a queue; and
playing the overlapping VoIP messages one at a time, wherein the playing comprises retrieving the at least one of the overlapping VoIP messages from the queue.

2. The method of claim 1, further comprising:
displaying messages from the VoIP conference through a graphical user interface (GUI); and
receiving instructions from a user through the GUI.

3. The method of claim 2, further comprising:
receiving through the GUI, specifications of messages from the VoIP conference to be deleted; and
deleting the specified messages, responsive to the receiving.

4. The method of claim 2, wherein the placing comprises:
receiving through the GUI, specifications on ordering the messages from the VoIP conference in the queue; and
ordering the messages, responsive to the specifications.

5. The method of claim 2, wherein the playing comprises:
receiving through the GUI, a specification of a message from the VoIP conference in the queue; and
playing the specified message, responsive to the specification.

6. The method of claim 1, further comprising:
alerting the receipt of a message from the VoIP conference.

7. The method of claim 1, wherein:
the method comprises placing separate speeches made during the VoIP conference in separate VoIP messages;
the receiving comprises receiving VoIP messages containing all of the speech uttered during the VoIP conference; and
the playing comprises playing separately the separate VoIP messages.

8. The method of claim 1, wherein the playing comprises:
retaining one of the at least one of the overlapping VoIP messages in the queue after playing; and
replaying the retained message.

9. The method of claim 1, wherein the playing comprises delaying the playing for a fixed period after the placing.

10. The method of claim 1, wherein the playing comprises:
receiving a specification of a delay; and
delaying the playing responsive to the specification.

11. An apparatus to play Voice over Internet Protocol (VoIP) messages, the apparatus comprising:
a receiver to receive overlapping VoIP messages from a VoIP conference;
a queue to queue at least one of the overlapping VoIP messages; and
a player to retrieve the at least one of the overlapping VoIP messages from the queue and to play the overlapping VoIP messages one at a time.

12. The apparatus of claim 11, further comprising a graphical user interface (GUI) to display messages from the VoIP conference and to receive instructions from a user.

13. The apparatus of claim 11, wherein the GUI comprises a module to receive specifications of messages from the VoIP conference and to play the specified messages.

14. A computer program product comprising a computer useable medium having a computer readable program, wherein the computer readable program when executed on a computer causes the computer to:
receive overlapping VoIP messages from a VoIP conference;
place at least one of the overlapping VoIP messages in a queue; and
play the overlapping VoIP messages one at a time, wherein the playing comprises retrieving the at least one of the overlapping VoIP messages from the queue.

15. The computer program product of claim 14, wherein the computer readable program when executed on a computer further causes the computer to:
display messages from the VoIP conference through a graphical user interface (GUI); and
receive instructions from a user through the GUI.

16. The computer program product of claim 14, wherein the placing comprises:
receiving through the GUI, specifications on ordering the messages from the VoIP conference in the queue; and
ordering the messages, responsive to the specifications.

17. The computer program product of claim 14, wherein the placing comprises:
receiving through the GUI, a specification of a message from the VoIP conference in the queue; and
playing the specified message, responsive to the specification.

18. The computer program product of claim 14, wherein the playing comprises:
retaining one of the at least one of the overlapping VoIP messages in the queue after playing; and
replaying the retained message.

19. The computer program product of claim 14, wherein:
the computer readable program when executed on a computer further causes the computer to place separate speeches made during the VoIP conference in separate VoIP messages;
the receiving comprises receiving VoIP messages containing all of the speech uttered during the VoIP conference; and
the playing comprises playing separately the separate VoIP messages.

20. The computer program product of claim 14, wherein the computer useable medium comprises a transmission medium.
